(19) United States
(12) Patent Application Publication
(10) Pub. No.: US 2019/0331070 A1
(43) Pub. Date: Oct. 31, 2019

(54) SCREEN FILTER FOR THE INTAKE OF A TURBOCHARGER OR SUPERCHARGER

(71) Applicant: Corey B. KENDALL, Norwood, NC (US)

(72) Inventor: Corey B. KENDALL, Norwood, NC (US)

(21) Appl. No.: 15/966,246

(22) Filed: Apr. 30, 2018

(51) Int. Cl. F02M 35/04; F02M 35/024; B01D 39/12; B01D 46/10; B01D 46/00

(52) U.S. Cl. CPC F02M 35/042; F02M 35/02416; F02M 35/02466; B01D 2279/60; B01D 46/10; B01D 46/0002; B01D 39/12

(57) ABSTRACT

A screen filter for an intake of a turbocharger/supercharger includes a coupling device and a securing means. The coupling device includes a hollow interior with an open end, a filter end and a width defined by the distance from the open end to the filter end. The open end is configured to fit around the intake of the turbocharger/supercharger. The filter end includes a screen. The securing means is configured to secure the coupling device around the intake of the turbocharger/supercharger. Wherein, when the coupling device is positioned around the intake of the turbocharger/supercharger, the screen at the filter end is positioned over an end of the intake of the turbocharger/supercharger.

### FIELD OF THE DISCLOSURE

The present disclosure is directed to turbochargers for engines, or centrifugal superchargers for engines. More specifically, the present disclosure is directed toward screen filters for the intake of a turbocharger or the intake of a centrifugal supercharger.

### BACKGROUND

A turbocharger, or colloquially turbo, is a turbine-driven forced induction device that increases an internal combustion engine's efficiency and power output by forcing extra air into the combustion chamber. This improvement over a naturally aspirated engine's power output is due to the fact that the compressor can force more air, and proportionately more fuel, into the combustion chamber than atmospheric pressure (and for that matter, ram air intakes) alone. Turbochargers were originally known as turbosuperchargers when all forced induction devices were classified as superchargers.

A supercharger is an air compressor that increases the pressure or density of air supplied to an internal combustion engine. This gives each intake cycle of the engine more oxygen, letting it burn more fuel and do more work, thus increasing power. Power for the supercharger can be provided mechanically by means of a belt, gear, shaft, or chain connected to the engine's crankshaft. Today the term “supercharger” is typically applied only to mechanically driven forced induction devices, also known as centrifugal superchargers.

The key difference between a turbocharger and a conventional supercharger is that a supercharger is mechanically driven by the engine, often through a belt connected to the crankshaft, whereas a turbocharger is powered by a turbine driven by the engine's exhaust gas. Compared with a mechanically driven supercharger, turbochargers tend to be more efficient, but less responsive. Twincharger refers to an engine with both a supercharger and a turbocharger. Turbochargers are commonly used on truck, car, train, aircraft, and construction equipment engines. They are most often used with Otto cycle and Diesel cycle internal combustion engines. They have also been found useful in automotive fuel cells.

Many people attempt to add a turbocharger or supercharger to their vehicle's engine to increase the horsepower. However, one problem that has been discovered with this addition to the engine compartment is the space required for the added turbocharger or supercharger. When people add superchargers or turbochargers to their engine compartment, the space in the engine compartment becomes limited. This poses an even bigger problem, when you need to install an air filter on the intake of the turbocharger or supercharger. Current air filters are cone style air filters that have a cone shape that extends off the intake of the turbocharger/supercharger. Sometimes engine compartments simply do not have room to use a normal, cone style, air filter. In most cases, when installing a common turbo charger on a vehicle, there is no room between the turbo and the fender for a normal, cone style, air filter. As such, there is clearly a need or desire to provide an air filter for the intake of a turbocharger or supercharger that requires less space or is more compact.

In addition to the space problem, performance enthusiast may also demand the most horsepower be made from their engine. Airflow into a turbocharger/supercharger's inlet or intake is key. Cone style air filters sometime restrict flow which, in return, reduces performance levels. On the other hand, if you choose not to run a filter at all, you risk your motor and power adder being damaged. You have no protection from debris going into the inlet of the turbocharger/supercharger. As examples, the intake of the turbocharger or supercharger could suck up a rock from the road or someone could even accidentally put their finger in the intake. As such, there is clearly a need to provide an air filter for the intake of a turbocharger or supercharger that is more efficient or allows more air to flow into the intake than the common cone style filters.

The instant disclosure is designed to address at least certain aspects of the problems or needs discussed above by providing the instant screen filter for the intake of a turbocharger.

### SUMMARY

Accordingly, in one aspect, the present disclosure embraces a screen filter for an intake of a turbocharger or supercharger (referred to herein as turbocharger/supercharger). The screen filter may generally include a coupling device and a securing means. The coupling device may include a hollow interior with an open end, a filter end, and a width defined by the distance from the open end to the filter end. The open end may be configured to fit around the intake of the turbocharger/supercharger. The filter end may include a screen. The securing means may be configured to secure the coupling device around the intake of the turbocharger/supercharger. Wherein, when the coupling device is positioned around the intake of the turbocharger/supercharger, the screen at the filter end may be positioned over an end of the intake of the turbocharger/supercharger. Whereby, air entering the intake must flow through the screen.

One feature of the instant screen filter may be that in select embodiments the screen at the filter end of the coupling device may be positioned adjacent the end of the intake of the turbocharger/supercharger, or directly on the end of the intake. As such, in these select embodiments, the clearance needed in the engine compartment for the instant screen filter may be the thickness of the screen on top of the intake. However, the disclosure is not so limited and the screen at the filter end of the coupling device may be positioned a distance from the end of the intake of the turbocharger/supercharger to provide any necessary clearance for any blades or propellers in the intake of the turbocharger/supercharger.

One feature of the instant screen filter may be that the screen positioned over the end of the intake of the turbocharger/supercharger may be configured to filter debris from entering the intake of the turbocharger/supercharger.

Another feature of the instant screen filter may be that the screen positioned over the end of the intake of the turbocharger/supercharger may be configured to allow substantially unrestricted air flow into the intake of the turbocharger/supercharger.

In select embodiments of the instant screen filter, the screen positioned over the end of the intake of the turbocharger/supercharger may be configured to filter debris from entering the intake of the turbocharger/supercharger, and to allow substantially unrestricted air flow into the intake of the turbocharger/supercharger.

In select embodiments of the instant screen filter, the screen may be a mesh screen. In select embodiments of the instant screen filter with the mesh screen, the mesh screen may be a stainless-steel mesh screen configured for, but is clearly not limited to, approximately or equal to 223 pounds per square inch bursting test.

In other select embodiments of the instant screen filter, the screen may be a wire screen. In select embodiments of the instant screen filter with the wire screen, the wire screen may be a stainless-steel honeycomb shaped wire screen including, but not limited to, an open area of approximately or equal to 81%. In select embodiments, the wire screen may be 10 or 20 gauge stainless-steel with 0.450 hex, 0.500 stage and an open area of 81%.

One feature of the instant screen filter may be that the coupling device may include a round cross-section with a constant radius.

Another feature of the instant screen filter may be that the hollow interior of the coupling device may extend from the open end to the filter end.

Another feature of the instant screen filter may be that the hollow interior may have an inner diameter configured to fit around the intake of the turbocharger/supercharger. In select embodiments, the inner diameter of the hollow interior may be, but is clearly not limited thereto, between 2.5 inches and 6.00 inches.

Another feature of the instant screen filter may be that the coupling device may have a hollow puck shape. Accordingly, the width of the coupling device may be smaller than an outer diameter to form the hollow puck shape of the instant screen filter. In select embodiments, the width of the coupling device may be substantially smaller than its outer diameter.

Another feature of the instant screen filter may be that the width of the coupling device may be sized to allow the securing means to secure the coupling device around the intake of the turbocharger/supercharger.

Another feature of the instant screen filter may be that the coupling device may be made from a flexible material. In select embodiments, the flexible material of the coupling device may be, but is clearly not limited to, rubber or silicone.

In select embodiments of the instant screen filter, the coupling device may be injection molded with the screen embedded in the filter end. As a result of injection molding, the screen filter may be a one-piece filter for the intake of the turbocharger/supercharger.

In select embodiments of the instant screen filter, the securing means may be a clamp. The clamp may be configured to wrap around the outside of the coupling device over the width of the coupling device. Whereby, when the coupling device is inserted over the intake of the turbocharger/supercharger, the clamp may be configured to secure the coupling device on the intake by squeezing the coupling device on the intake. In select embodiments, the coupling device may include a channel around the outside of the coupling device between the open end and the filter end configured for maintaining the position of the clamp around the coupling device. In select embodiments, the clamp may be, but is clearly not limited thereto, a stainless-steel t-bolt clamp, or a stainless-steel worm gear clamp.

Another feature of the instant screen filter may be that it can be configured to allow an engine to gain approximately or equal to 51.4 HP over a standard cone style filter.

Another feature of the instant screen filter may be that it can be configured to allow an engine to gain approximately or equal to 23.2 ft/lbs of torque over the standard cone style filter.

In select embodiments, the instant screen filter may be configured to allow an engine to gain approximately or equal to 51.4 HP over a standard cone style filter, and to allow an engine to gain approximately or equal to 23.2 ft/lbs of torque over the standard cone style filter.

In another aspect, the instant disclosure may be directed toward the intake of a turbocharger/supercharger that includes the instant screen filter in any of the embodiments shown and/or described herein. As such, the instant screen filter included on the intake of the turbocharger/supercharger may generally include a coupling device and a securing means. The coupling device may include a hollow interior with an open end, a filter end, and a width defined by the distance from the open end to the filter end. The open end may be configured to fit around the intake of the turbocharger/supercharger. The filter end may include a screen. The securing means may be configured to secure the coupling device around the intake of the turbocharger/supercharger. Wherein, when the coupling device is positioned around the intake of the turbocharger/supercharger, the screen at the filter end may be positioned over an end of the intake of the turbocharger/supercharger whereby air entering the intake must flow through the screen.

One feature of the instant intake for the turbocharger/supercharger may be that the screen positioned adjacent the end of the intake of the turbocharger/supercharger may be configured to filter debris from entering the intake of the turbocharger/supercharger.

Another feature of the instant intake for the turbocharger/supercharger may be that the screen positioned adjacent the end of the intake of the turbocharger/supercharger may be configured to allow substantially unrestricted air flow into the intake of the turbocharger/supercharger.

In select embodiments of the instant intake for the turbocharger/supercharger, the screen positioned adjacent the end of the intake of the turbocharger/supercharger may be configured to filter debris from entering the intake of the turbocharger/supercharger, and to allow substantially unrestricted air flow into the intake of the turbocharger/supercharger.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a front perspective view of a screen filter for the intake of a turbocharger or a supercharger according to select embodiments of the instant disclosure with a mesh screen;

FIG. 2 is a rear perspective view of the screen filter from FIG. 1;

FIG. 3 is a top view of the screen filter from FIG. 1;

FIG. 4 is a bottom view of the screen filter from FIG. 1;

FIG. 5 is a right side view of the screen filter from FIG. 1;

FIG. 6 is a left side view of the screen filter from FIG. 1;

FIG. 7 is a top view of the screen filter from FIG. 1;

FIG. 8 is a bottom view of the screen filter from FIG. 1;

FIG. 9 is a cross-sectional view of the screen filter from FIG. 1 showing a zoomed in view of the mesh screen;

FIG. 10 is a perspective view of a turbocharger with the screen filter from FIG. 1 covering the intake;

FIG. 11 is a partially disassembled view of the turbocharger from FIG. 10 with the screen filter from FIG. 1 partially disassembled from the intake;

FIG. 12 is a side view of the turbocharger from FIG. 10;

FIG. 13 is a front perspective view of a screen filter for the intake of a turbocharger or a supercharger according to select embodiments of the instant disclosure with a wire honeycomb screen;

FIG. 14 is a rear perspective view of the screen filter from FIG. 13;

FIG. 15 is a top view of the screen filter from FIG. 13;

FIG. 16 is a bottom view of the screen filter from FIG. 13;

FIG. 17 is a right side view of the screen filter from FIG. 13;

FIG. 18 is a left side view of the screen filter from FIG. 13;

FIG. 19 is a top view of the screen filter from FIG. 13;

FIG. 20 is a bottom view of the screen filter from FIG. 13;

FIG. 21 is a cross-sectional view of the screen filter from FIG. 13;

FIG. 22 is a perspective view of a turbocharger with the screen filter from FIG. 13 covering the intake;

FIG. 23 is a partially disassembled view of the turbocharger from FIG. 22 with the screen filter from FIG. 13 partially disassembled from the intake;

FIG. 24 is a side view of the turbocharger from FIG. 22; and

FIGS. 25A and 25B are split graphical view of the results of dyno testing a screen filter according to select embodiments of the instant disclosure and a standard cone style filter, showing the results power in HP and Torque in lb-ft vs. engine speed in RPM×1000;

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

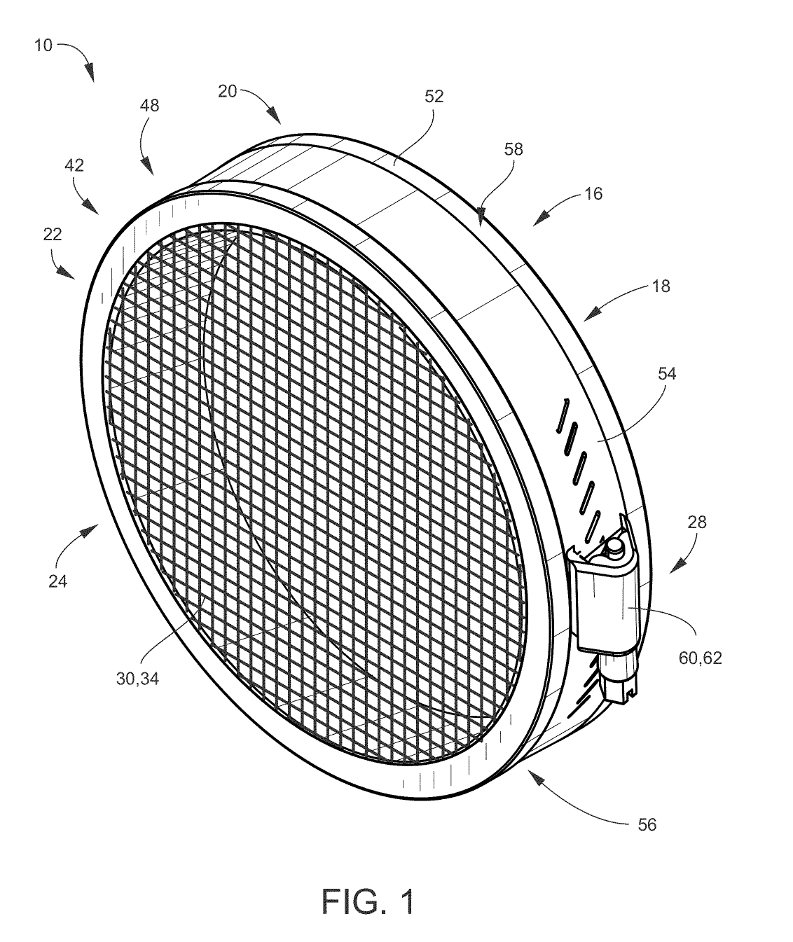

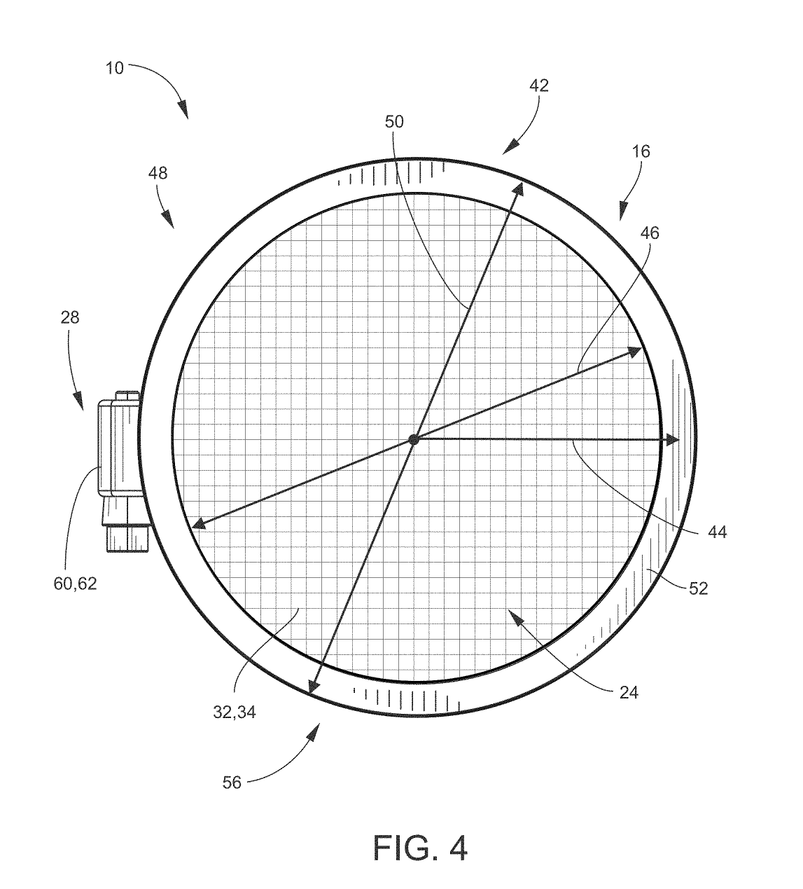

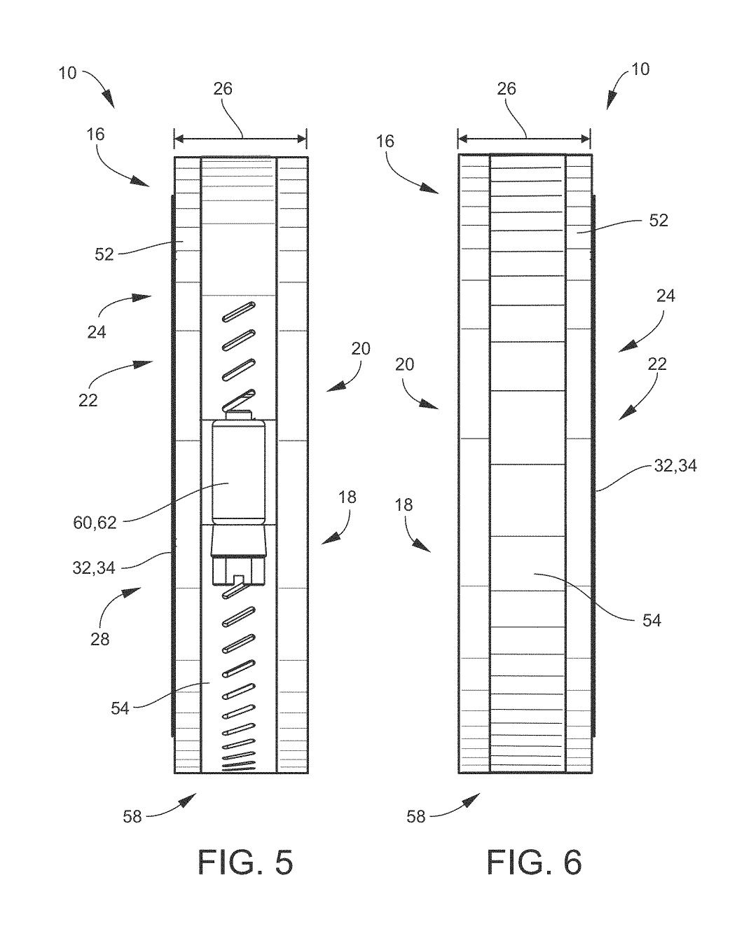

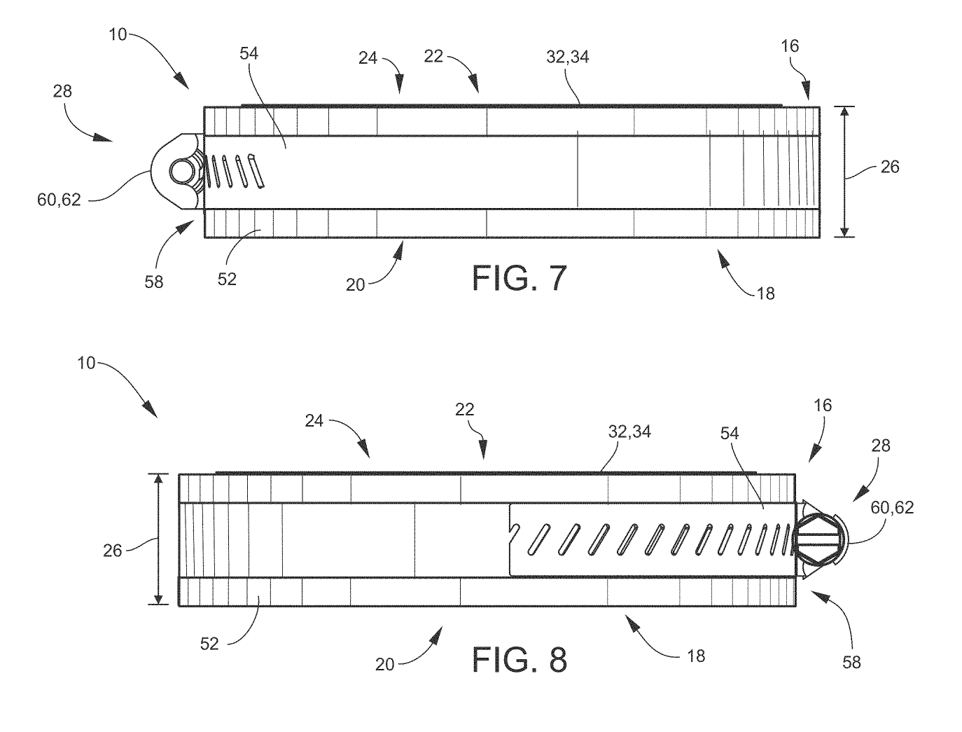

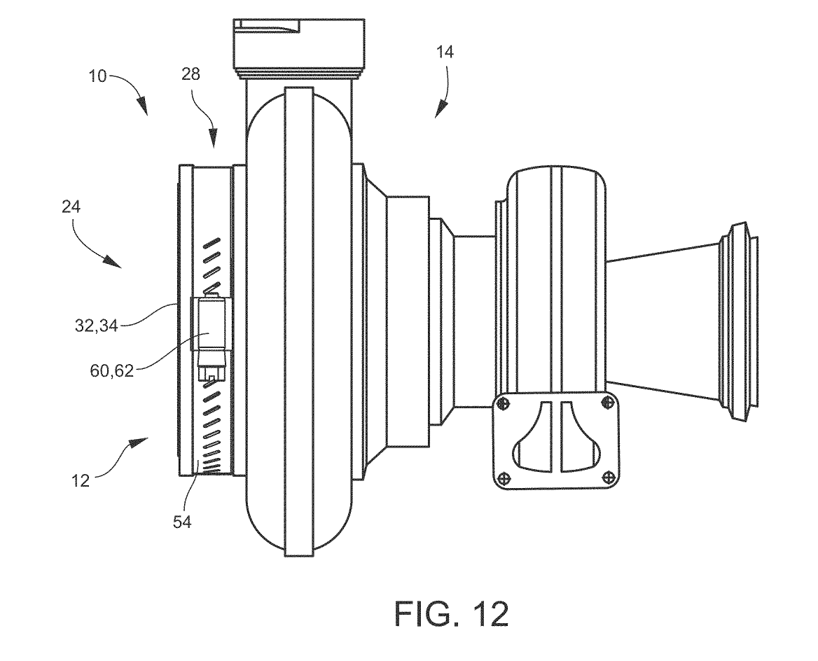

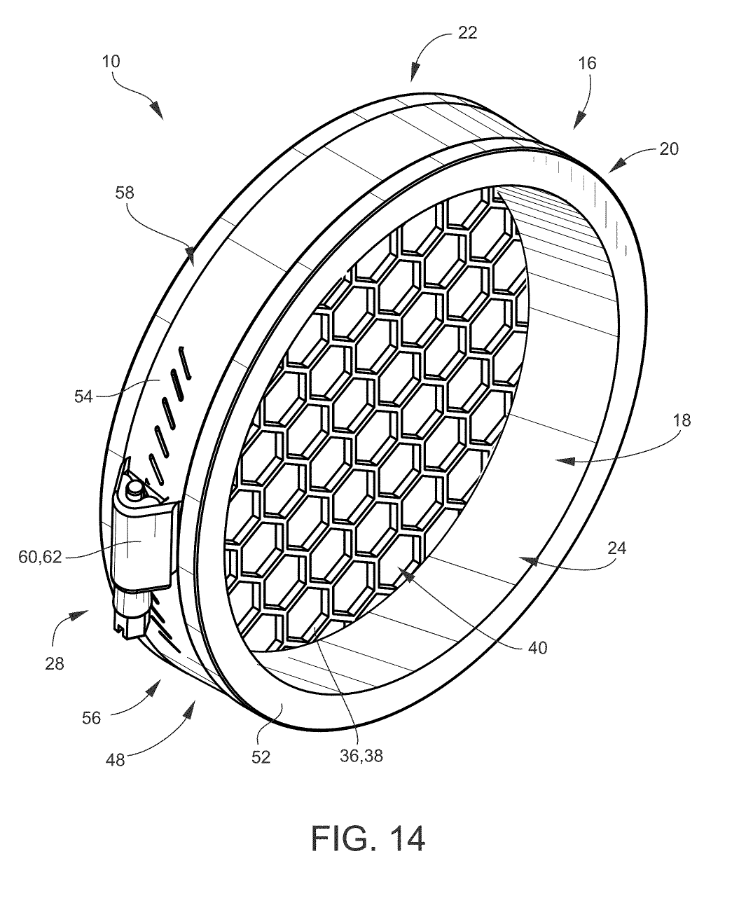

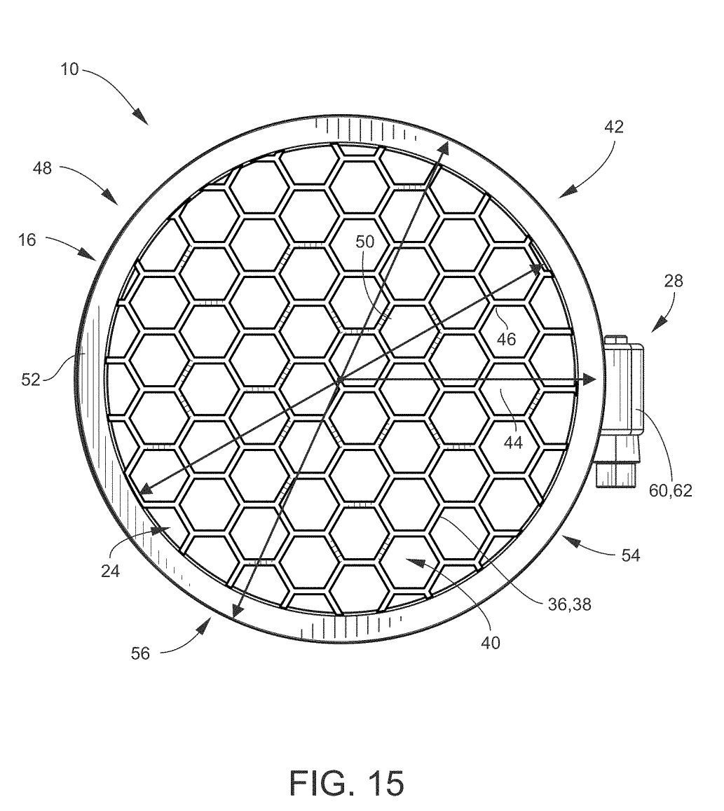

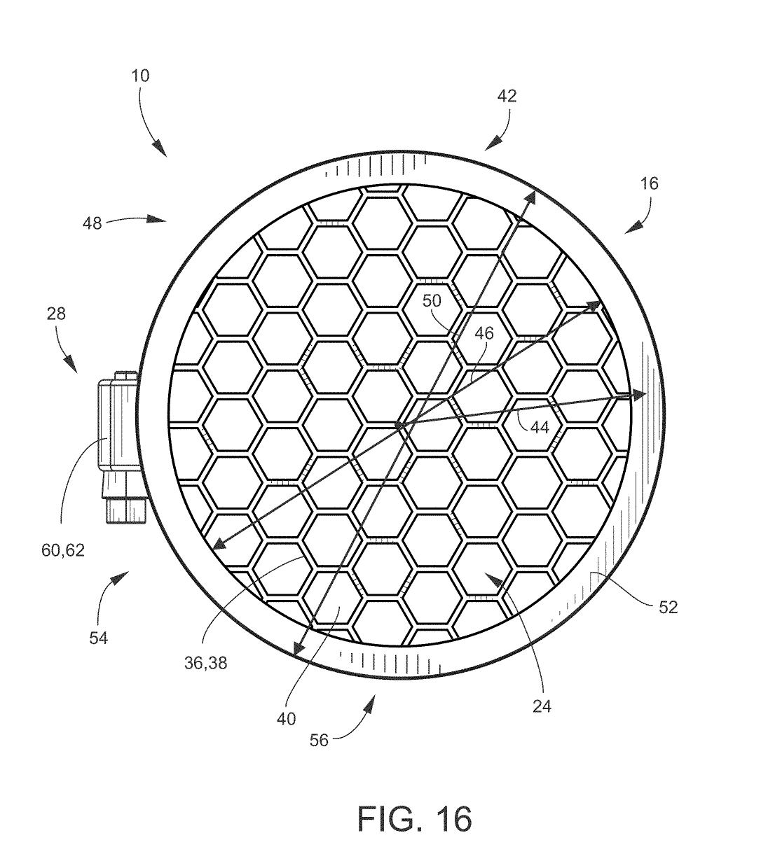

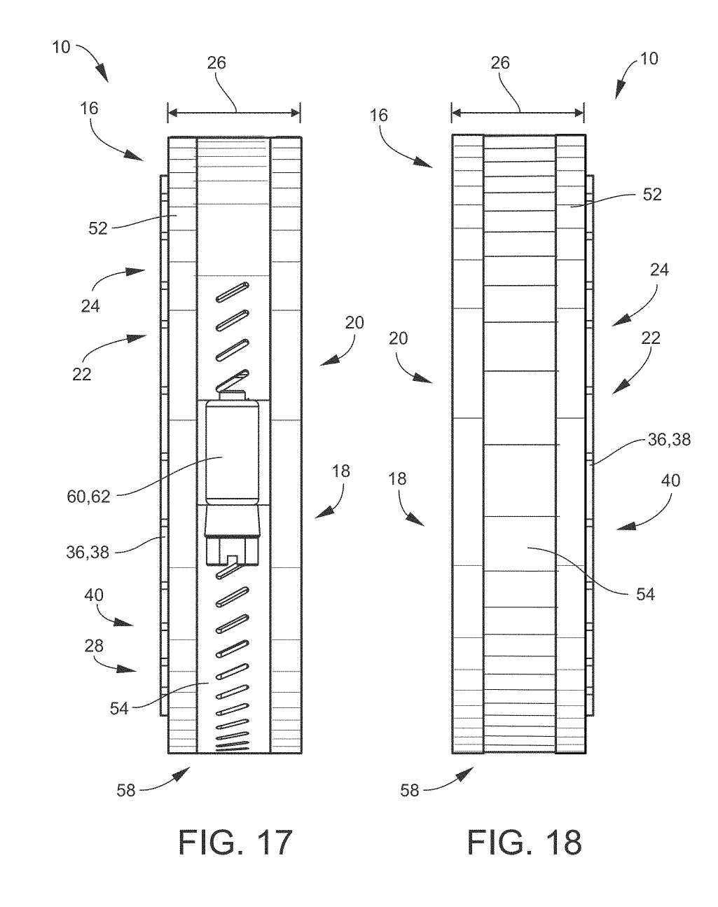

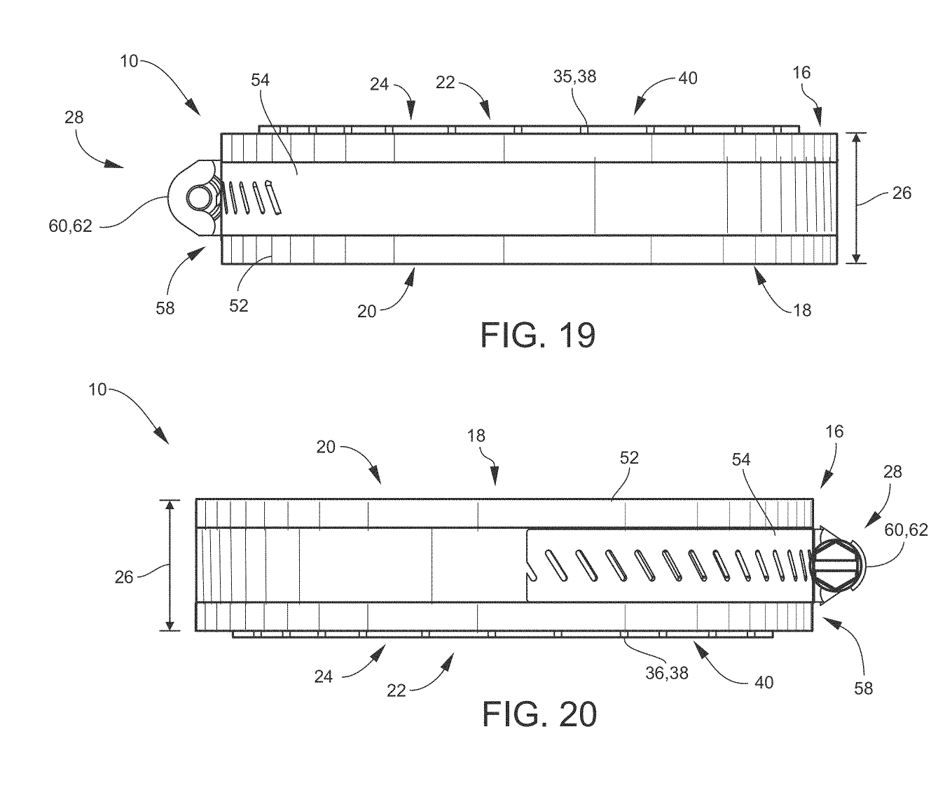

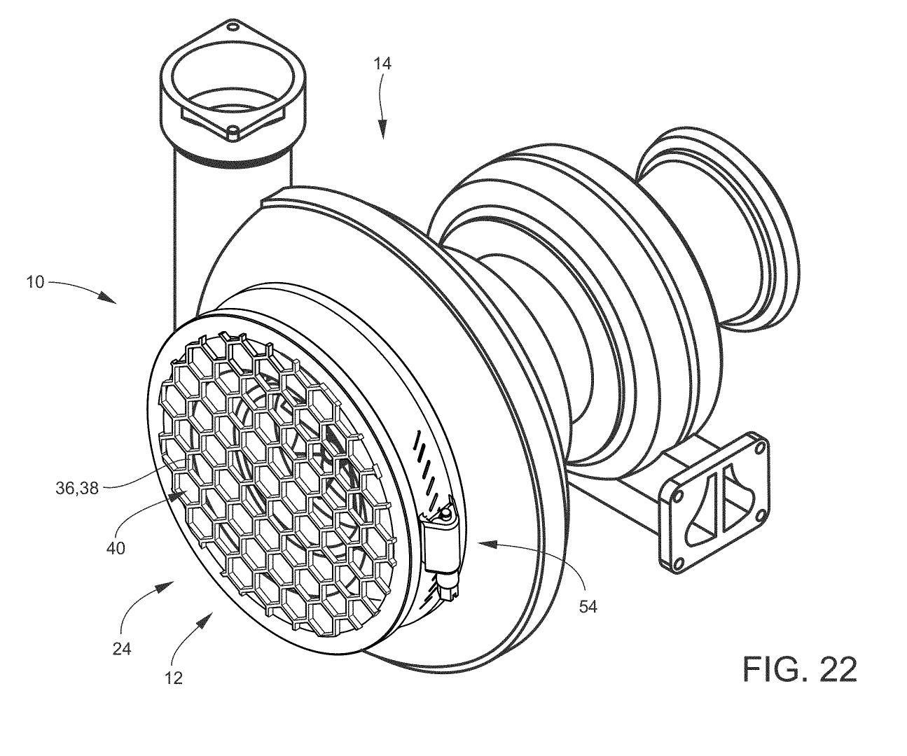

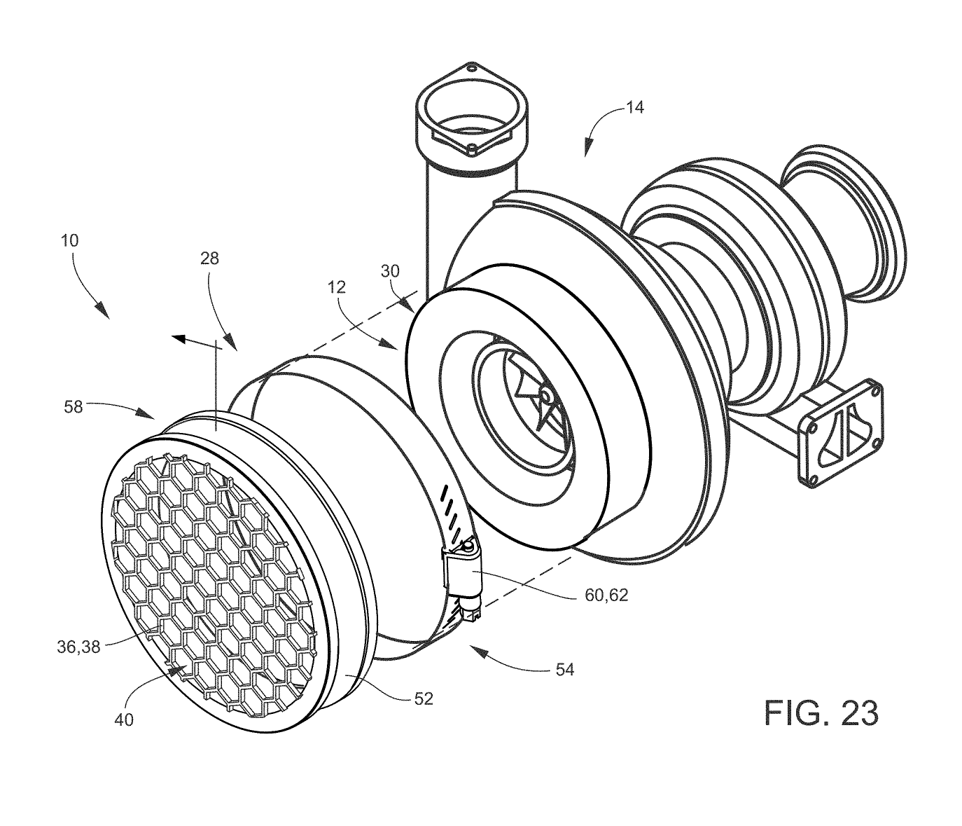

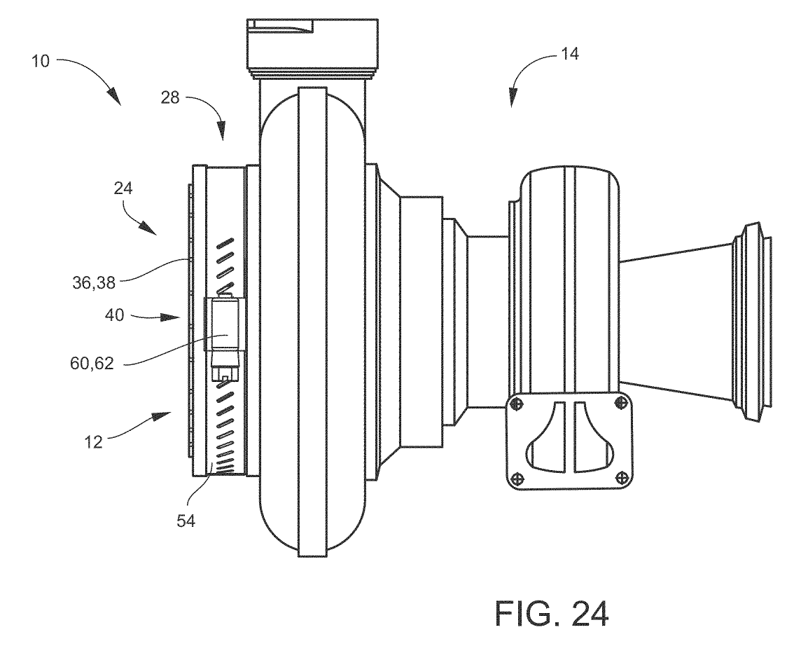

Referring now to FIGS. 1-25, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring now to FIGS. 1-24, in a possibly preferred embodiment, the present disclosure overcomes the above-mentioned disadvantages and meets the recognized need for such an apparatus or method by providing of screen filter 10. Screen filter 10 may be for being positioned on intake 12 of turbocharger/supercharger 14. Turbocharger/supercharger 14, as used herein, may include any various forms of turbochargers or superchargers, including, but not limited to the turbocharger 14 shown in the Figures. The instant screen filter 10 may thus be designed to fit the intake 12 of any turbocharger or supercharger, whether currently known or later developed. As commonly known by one skilled in the art, intake 12 may be the opening, inlet, conduit, the like, etc., where air is pulled into turbocharger/supercharger 14. As such, by placing screen filter 10 on intake 12, air entering intake 12 must flow through screen filter 10. As shown in FIGS. 1-24, screen filter 10 may generally include coupling device 16 with screen 24 and securing means 28. These parts and their purposes or functions will be described in detail below.

Coupling device 16 may be included in the instant screen filter 10 for intake 12 of turbocharger/supercharger 14. See FIGS. 1-24. Coupling device 16 may provide the main body of screen filter 10. Coupling device 16 may be configured to couple or secure screen filter 10 to intake 12 of turbocharger/supercharger 14 while positioning screen 24 over intake 12 of turbocharger/supercharger 14. Coupling device 16 may include hollow interior 18 with open end 20, filter end 22, and width 26. Width 26 may be defined by the distance from open end 20 to filter end 22. Open end 20 may be configured to fit around intake 12 of turbocharger/supercharger 14. In select embodiments, open end 20 may be configured to fit snug around intake 12 of turbocharger/supercharger 14, or where the size of open end 20 is slightly larger than intake 12, the same size as intake 12, or slightly smaller than intake 12. In select possibly preferred embodiments, open end 20 may be sized slightly smaller than intake 12, thereby providing some friction resistance for securing screen filter 10 on intake 12. Filter end 22 of coupling device 16 may include screen 24.

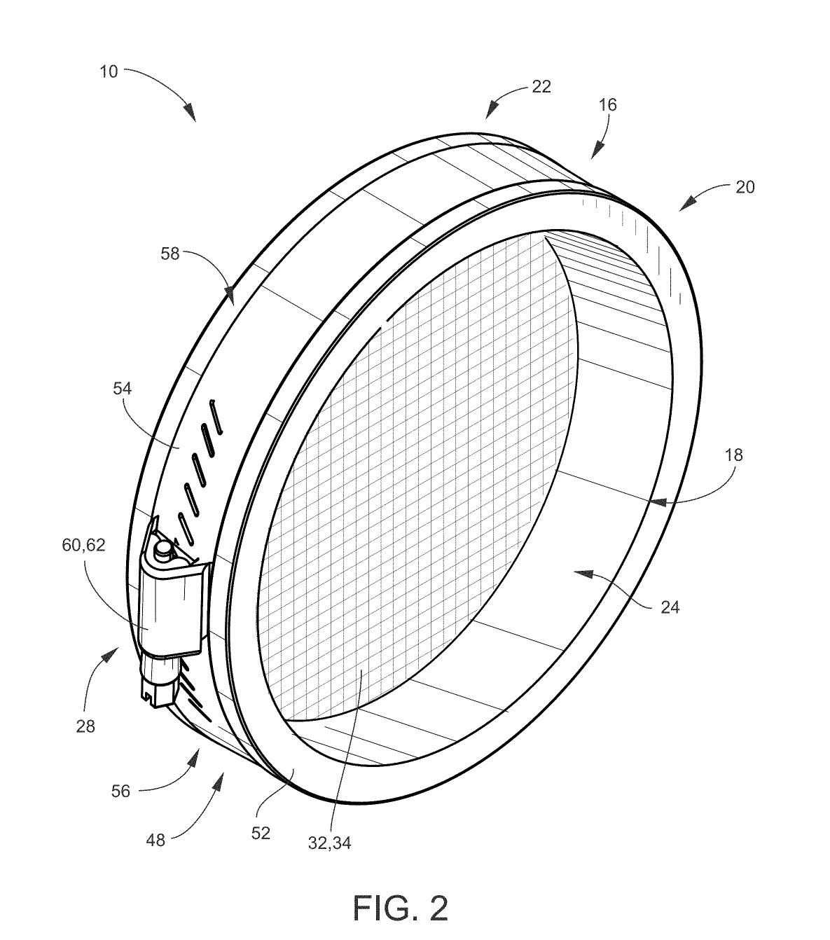

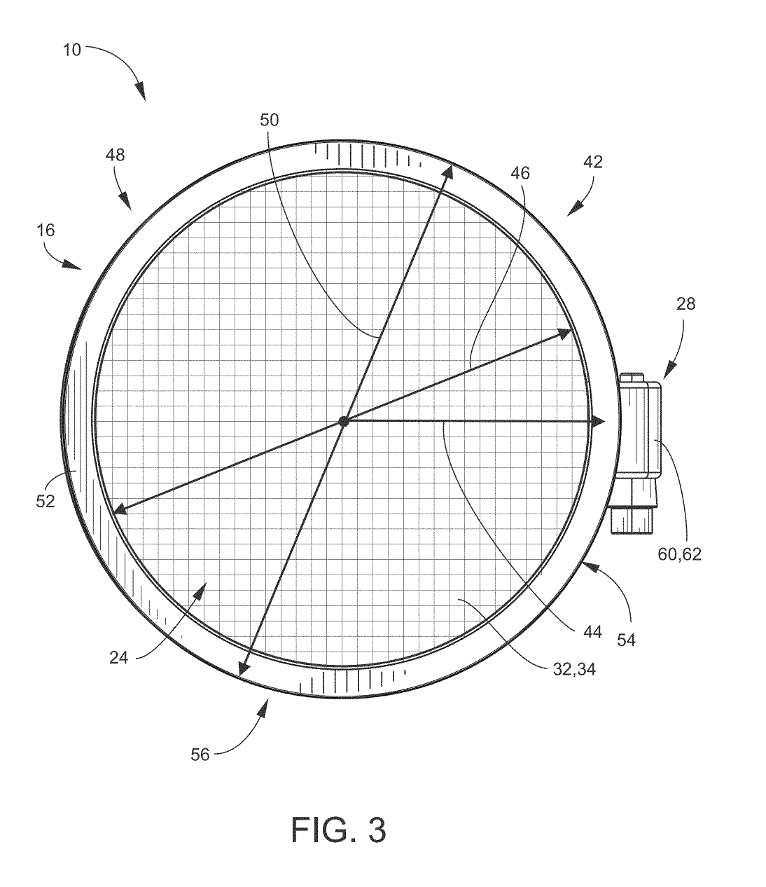

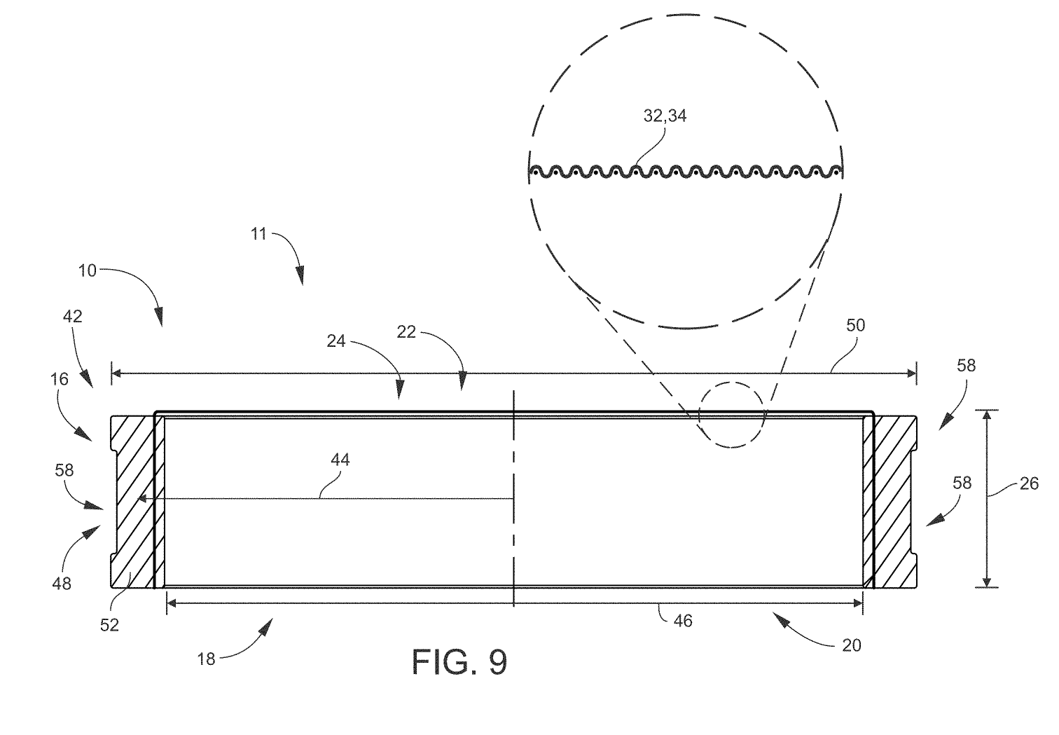

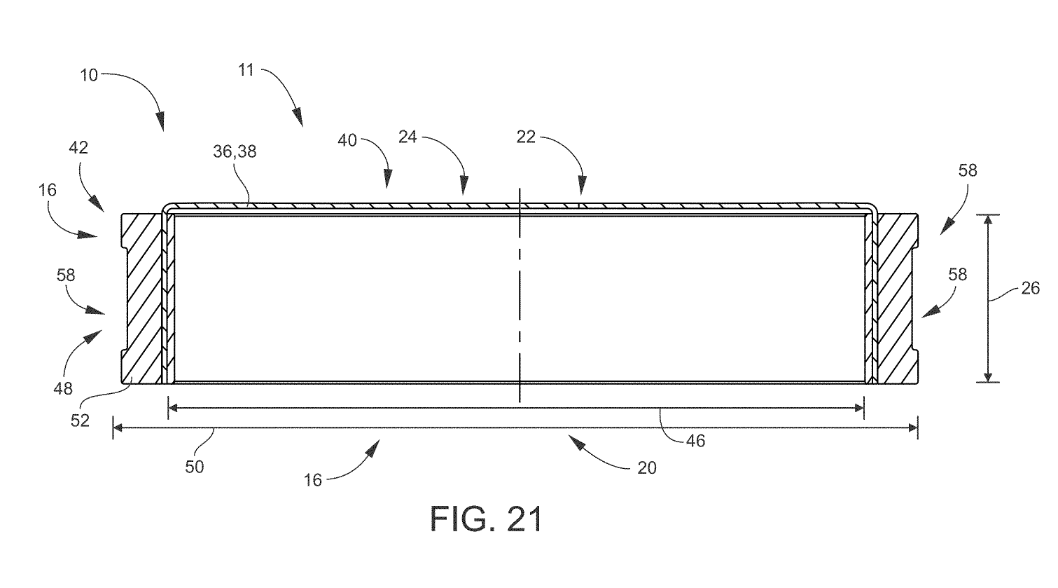

Coupling device 16 may include any shape or size configured for any shape or size intake 12 for various size and shapes of turbochargers or superchargers. As such, in select embodiments, as shown in the FIGS. 1-24, coupling device 16 may include round cross-section 42. Round cross-section 42 may have radius 44. In select embodiments, radius 44 may be constant throughout width 26 of coupling device. In these constant radius 44 embodiments, coupling device 16 may not flare out or in, like to create a cone or similar type shape. As shown in FIGS. 2, 9, 14 and 21, hollow interior 18 of coupling device 16 may extend from open end 20 to filter end 22. As shown in FIGS. 3, 4, 9 15, 16 and 21, hollow interior 18 may have inner diameter 46. Inner diameter 46 may be configured to fit around intake 12 of turbocharger/supercharger 14. Inner diameter 46 may be sized to fit any size or shape intake 12. As examples, and clearly not limited thereto, in select embodiments, inner diameter 46 of hollow interior 18 may be between 2.5 inches and 6.00 inches. These dimensions of inner diameter 46 may coincide with most intakes of known or common turbochargers or superchargers. As shown in the Figures, in select embodiments, coupling device 16 may have hollow puck shape 48. Accordingly, width 26 of coupling device 16 may be smaller than outer diameter 50 of coupling device 16 to form the hollow puck shape. In select embodiments, width 26 of coupling device 16 may be substantially smaller (at least twice as small) than outer diameter 50 of coupling device 16 to form hollow puck shape 48. However, with that in mind, width 26 of coupling device 16 may be sized to allow securing means 28 to secure coupling device 16 around intake 12 of turbocharger/supercharger 14. Coupling device 16 may be made from any desired material. In select embodiments, coupling device 16 may be made from flexible material 52. Constructing coupling device 16 out of flexible material 52 may allow for open end 20 and hollow interior 18 to fit snug around intake 12. In addition, flexible material 52 may allow for securing means 28 to squeeze or compress coupling device 16 for securing coupling device 16 onto intake 12. Flexible material 52 of coupling device 16 may be any desired flexible material. In select embodiments, flexible material 52 of coupling device 16 may be, but is clearly not limited to, rubber or silicone, like flexible rubber materials, or flexible silicone materials. As an example, and clearly not limited thereto, in select embodiments, flexible material 52 of coupling device 16 may be Smooth-Sil™ Series Smooth-Sil™ 960 provided by Smooth-On (www.smooth-on.com) of Macungie, Pa. With these flexible materials, in select embodiments of screen filter 10, the coupling device 16 may be injection molded with screen 24 embedded in filter end 22 and down into coupling device 16 through width 26. This injection molding of screen filter 10 may thereby create one-piece filter 11 for intake 12 of turbocharger/supercharger 14, as shown in the FIGS. 9 and 21.

Screen 24 may be included with screen filter 10 for intake 12 of turbocharger/supercharger 14. Screen 24 may be for preventing debris from entering intake 12 of turbocharger/supercharger 14. At the same time, screen 24 may be designed to allow unrestricted or substantially unrestricted air flow into intake 12 of turbocharger/supercharger 14. Screen 24 may be positioned on filter end 22 of coupling device 16. Screen 24 may be secured by any means on filter end 22. In select embodiments, screen 24 may be embedded in coupling device 16, like during manufacturing or molding (including, but not limited to, injection molding) of coupling device 16. As shown in FIGS. 9 and 21, screen 24 may be bent or folded down and embedded down width 26 just inside inner diameter 46. Screen 24 may be any size or type of desired screen or filter. In select embodiments, screen 24 may be positioned adjacent or directly on top of end 30 of intake 12 of turbocharger/supercharger 14. This position of screen 24 directly on end 30 of intake 12 may allow for minimum space or clearance in the engine compartment for attaching screen filter 10 on intake 12. However, the disclosure is not so limited, and screen 24 may be spaced away from end 30 of intake 12, like for providing clearance from any blades or propellers inside intake 12 of turbocharger/supercharger 14.

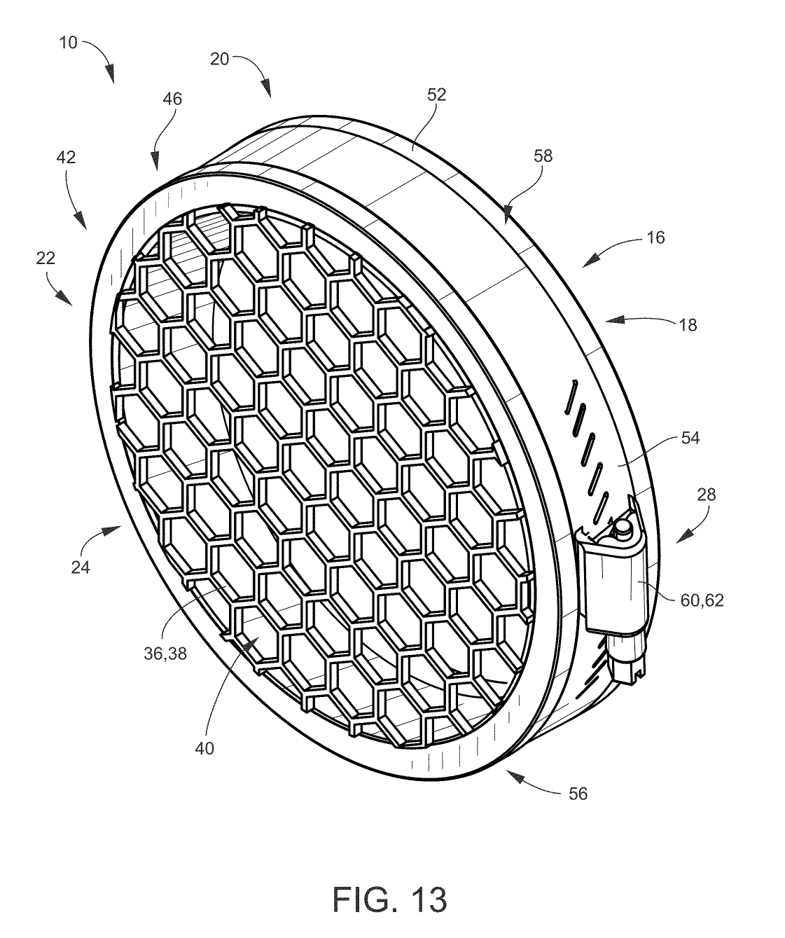

Referring specifically now to FIGS. 1-12, in select embodiments of screen filter 10, screen 24 may be mesh screen 32. Mesh screen 32 may provide for filtering or preventing relatively small objects or debris from entering intake 12 of turbocharger/supercharger 14. Mesh screen 32 may provide for filtering or preventing of smaller objects or debris from entering intake 12 of turbocharger/supercharger 14 than wire screen 36, as shown in FIGS. 13-24. At the same time, mesh screen 32 may be designed to allow for unrestricted or substantially unrestricted air flow into intake 12. Mesh screen 32 may be any size or type of mesh screen or similar device or material. In select embodiments, mesh screen 32 may be stainless-steel mesh screen 34, as shown in the Figures. The stainless-steel mesh screen 34 may be any stainless-steel mesh screen, or the like. As an example, and clearly not limited thereto, in select embodiments, stainless-steel mesh screen 34 may be configured for greater than 100 pounds per square inch bursting test. In select, possibly preferred embodiments, stainless-steel mesh screen 34 may be configured for greater than 200 pounds per square inch bursting test. In select, possibly most preferred embodiments, stainless-steel mesh screen 34 may be configured for approximately or equal to 223 pounds per square inch bursting test.

Referring specifically now to FIGS. 13-24, in select embodiments of screen filter 10, screen 24 may be wire screen 36. Wire screen 36 may provide for filtering or preventing objects or debris from entering intake 12 of turbocharger/supercharger 14. At the same time, wire screen 36 may allow for unrestricted or substantially unrestricted air flow into intake 12 via open area 40. Wire screen 36 may be any size or type of wire screen or similar device. In select embodiments, wire screen 36 may be stainless-steel wire screen 38, as shown in the Figures. The stainless-steel wire screen 38 may be any stainless-steel wire screen, or the like. As an example, and clearly not limited thereto, in select embodiments, stainless-steel wire screen 38 may have a honeycomb shape, as shown in the Figures. However, the disclosure is not so limited, and any shape of wire screen 36 may be included, including, but not limited to, square shaped, diamond shaped, circular shaped, oval shaped, triangular shaped, the like, etc. Wire screen 36 may provide for increased strength over mesh screen 32, as shown in FIGS. 1-12. In addition, wire screen 36 may provide for more unrestricted air flow into intake 12 than mesh screen 32, as shown in FIGS. 1-12. In select embodiments, wire screen 36 may include, but is not limited to, open area 40 of greater than 60%. In other possibly preferred embodiments, wire screen 36 may include open area 40 of greater than 75%. In other possibly most preferred embodiments, wire screen 36 may include open area 40 of approximately or equal to 81%. As an example, and clearly not limited thereto, in select embodiments, wire screen 36 may be 10 or 20 gauge stainless-steel with 0.450 hex, 0.500 stage and open area 40 of 81%.

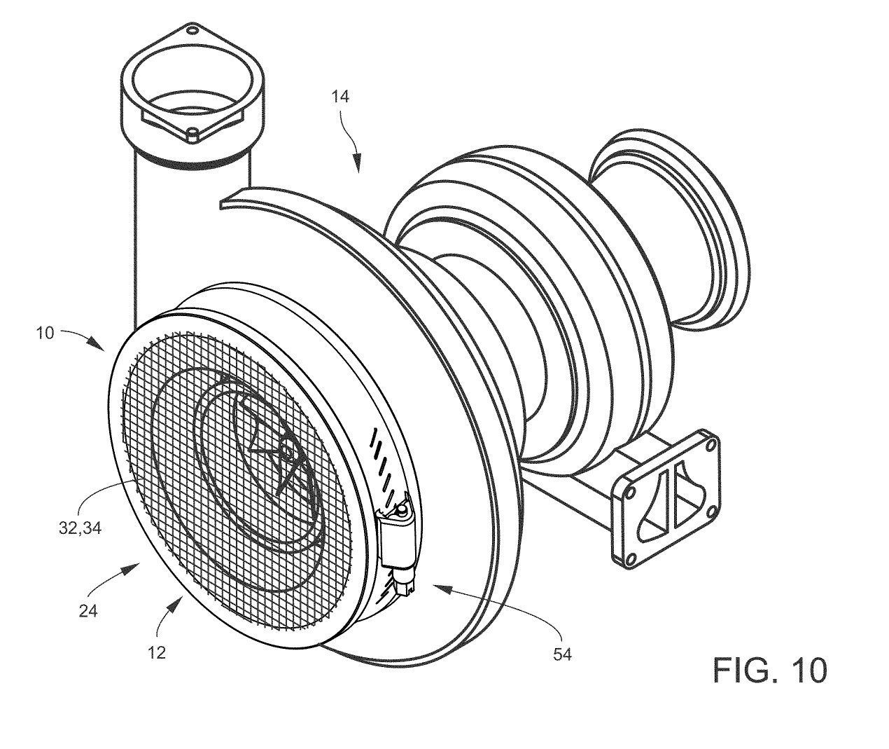

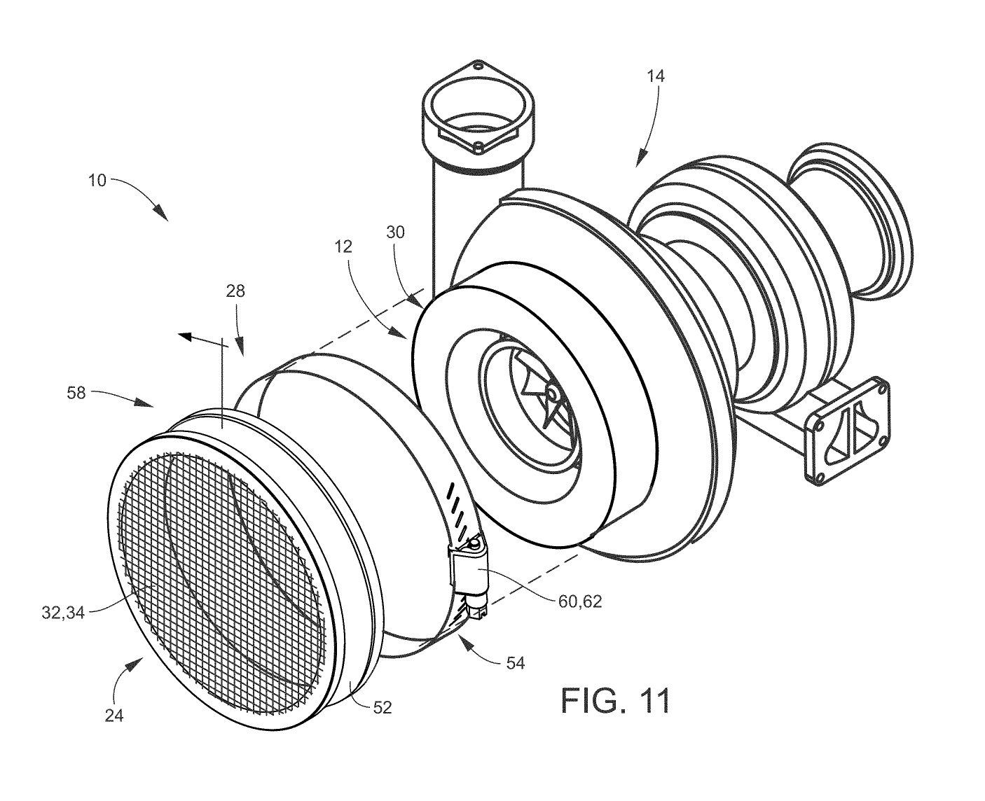

Securing means 28 may be included with screen filter 10 for intake 12 of turbocharger/supercharger 14. See FIGS. 1-24. Securing means 28 may be for securing coupling device 16 on intake 12 of turbocharger/supercharger 14. Securing means 28 may be any device, devices, mechanisms, materials, the like, or combinations thereof configured for securing coupling device 16 on intake 12 of turbocharger/supercharger 14. Securing means 28 may be configured to secure coupling device 16 around intake 12 of turbocharger/supercharger 14. In select embodiments of screen filter 10, securing means 28 may be, but is not limited to, clamp 54, as shown in the Figures. Clamp 54 may be configured to wrap around outside 56 of coupling device 16 over width 26 of coupling device 16. Whereby, when coupling device 16 is inserted over intake 12 of turbocharger/supercharger 14, as shown in FIGS. 10, 11, 12, 22, 23 and 24, clamp 54 may be configured to secure coupling device 16 on intake 12 by squeezing coupling device 16 on intake 12. This squeeze from clamp 54 may provide a uniform pressure around intake 12 for providing an air tight seal via flexible material 52, whereby air flowing into intake 12 must flow through screen 24. In select embodiments, coupling device 16 may include channel 58 around outside 56 of coupling device 16, as best shown in FIGS. 9, 11, 21 and 23. Channel 58 may be configured for maintaining the position of clamp 54 around coupling device 16. Channel 58 may be on width 26 between open end 20 and filter end 22. In select embodiments, channel 58 may be centered in width 26 between open end 20 and filter end 22. As a result of channel 58, a top lip and a bottom lip may be created on open end 20 and filter end 22, respectively. In select embodiments, clamp 54 may be, but is clearly not limited thereto, stainless-steel t-bolt clamp 60, stainless-steel worm gear clamp 62, the like, or combinations thereof.

As shown in FIGS. 10-12 and 22-24, when coupling device 16 is positioned around intake 12 of turbocharger/supercharger 14, screen 24 at filter end 22 may be positioned over end 30 of intake 12 of turbocharger/supercharger 14. One feature of screen filter 10 may be that the position of screen 24 adjacent end 30 of intake 12 of turbocharger/supercharger 14 may be configured to filter debris from entering intake 12 of turbocharger/supercharger 14. Another feature of screen filter 10 may be that screen 24 positioned adjacent end 30 of intake 12 of turbocharger/supercharger 14 may be configured to allow substantially unrestricted air flow into intake 12 of turbocharger/supercharger 14. In select embodiments of screen filter 10, screen 24 positioned adjacent end 30 of intake 12 of turbocharger/supercharger 14 may be configured to filter debris from entering intake 12 of turbocharger/supercharger 14, and at the same time, to allow substantially unrestricted air flow into intake 12 of turbocharger/supercharger 14.

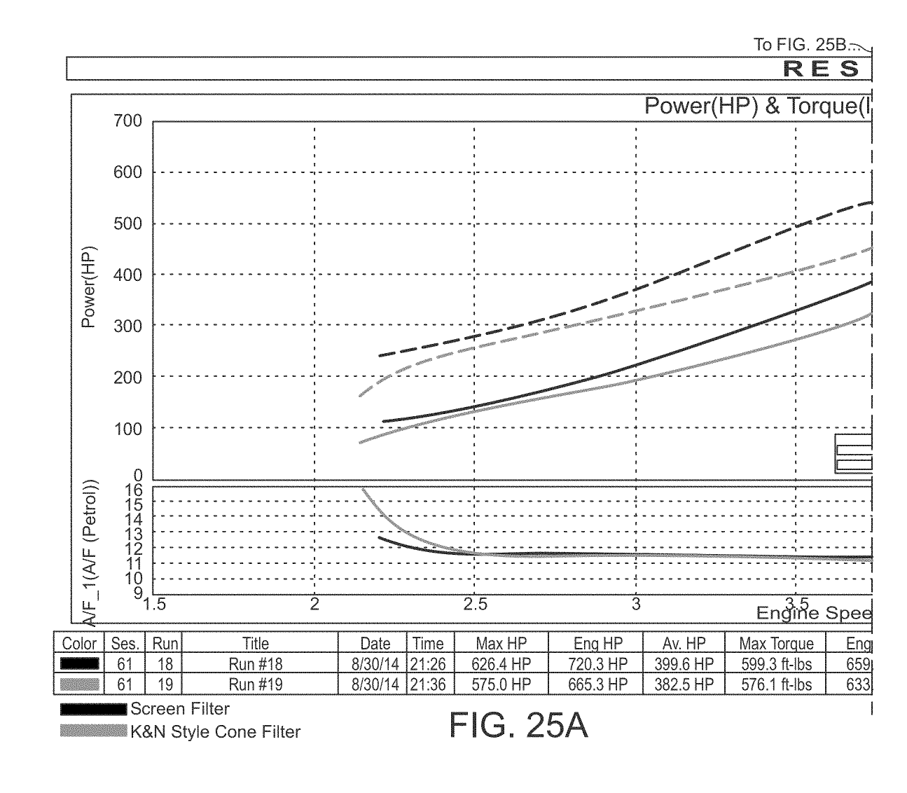

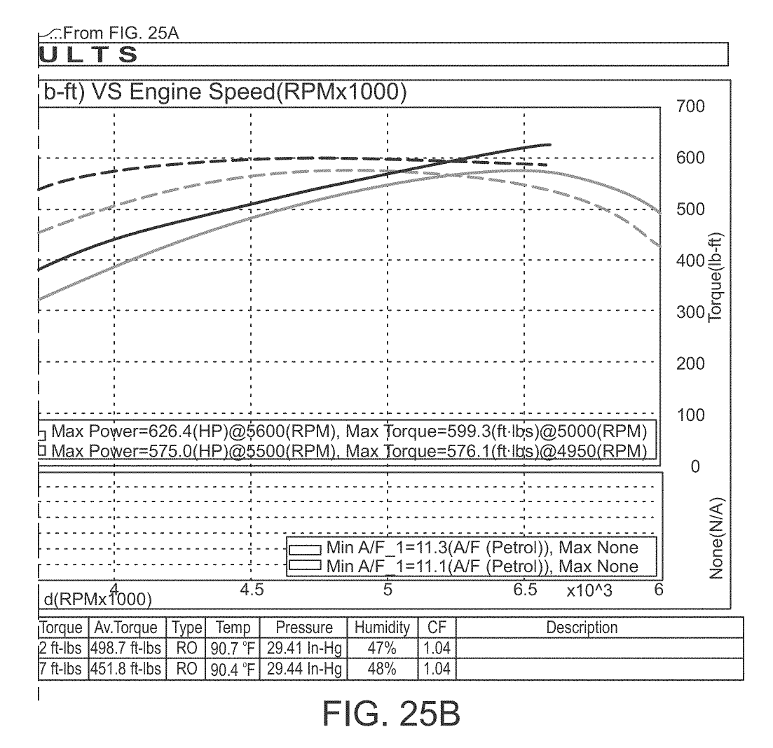

Referring now to FIGS. 25A and 25B, results of dyno testing of screen filter 10 (as shown in FIGS. 1-12 with mesh screen 32) and a standard cone style filter are shown. The results are shown for power in HP and Torque in lb-ft vs. engine speed in RPM×1000. As a result, another feature of screen filter 10 may be that it can be configured to allow an engine to gain over 10 HP over a standard cone style filter, possibly preferably a gain of 40 HP or more over a standard cone style filter, and possibly most preferred, as shown in the graph, a gain of approximately or equal to 51.4 HP over a standard cone style filter. In addition, another feature of screen filter 10 may be that it can be configured to allow an engine to gain over 10.0 ft/lbs of torque over a standard cone style filter, possibly preferably a gain of 20.0 ft/lbs of torque over a standard cone style filter, and possibly most preferred, as shown in the graph, a gain of approximately or equal to 23.2 ft/lbs of torque over the standard cone style filter. In select embodiments, screen filter 10 may be configured to allow an engine to gain approximately or equal to 51.4 HP over a standard cone style filter, and to allow an engine to gain approximately or equal to 23.2 ft/lbs of torque over the standard cone style filter.

In another aspect, as shown in FIGS. 10-12 and 22-24, the instant disclosure may be directed toward intake 12 of turbocharger/supercharger 14 that includes screen filter 10 in any of the embodiments shown and/or described herein. As such, screen filter 10 included on intake 12 of turbocharger/supercharger 14 may generally include coupling device 16 and securing means 28. Coupling device 16 may include hollow interior 18 with open end 20, filter end 22, and width 26 defined by the distance from open end 20 to filter end2. Open end 20 may be configured to fit around intake 12 of turbocharger/supercharger 14. Filter end 22 may include screen 24. Securing means 28 may be configured to secure coupling device 16 around intake 12 of turbocharger/supercharger 14. Wherein, when coupling device 16 is positioned around intake 12 of turbocharger/supercharger 14, screen 24 at filter end 22 may be positioned over end 30 of intake 12 of turbocharger/supercharger 14. One feature of intake 12 for turbocharger/supercharger 14 may be that screen 24 positioned adjacent end 30 of intake 12 of turbocharger/supercharger 14 may be configured to filter debris from entering intake 12 of turbocharger/supercharger 14. Another feature of intake 12 for turbocharger/supercharger 14 may be that screen 24 positioned adjacent end 30 of intake 12 of turbocharger/supercharger 14 may be configured to allow substantially unrestricted air flow into intake 12 of turbocharger/supercharger 14. In select embodiments of intake 12 for turbocharger/supercharger 14, screen 24 positioned adjacent end 30 of intake 12 of turbocharger/supercharger 14 may be configured to filter debris from entering intake 12 of turbocharger/supercharger 14, and to allow substantially unrestricted air flow into intake 12 of turbocharger/supercharger 14.

In sum, the instant disclosure may be directed to screen filter 10 for intake 12 of turbocharger/supercharger 14. The slim design of screen filter 10 may allow screen filter 10 to be installed in tight engine bay compartments where other bulky air filters will not fit. Turbos and superchargers often “cramp” the engine bay and you do not have room to run a normal air filter, like the common cone style filter. The instant disclosure may be designed to be used on the race track where most people take their filters off to increase air flow. The instant screen filter 10 has been dyno proven to not decrease horsepower when added to intake 12 of turbocharger/supercharger 14. An increase may actually occur when replacing standard cone style air filters, as shown in FIGS. 25A and 25B. With the instant screen filter 10 installed, protection may be provided against large debris, like rocks or pebbles, getting sucked into intake 12 and damaging the turbine of turbocharger/supercharger 14. The instant screen filter 10 may also protect from body parts, like fingers, from accidently getting inserted into the rotating impeller of turbocharger/supercharger 14. As such, the instant screen filter 10 may provide protection for the user and the vehicle.

Through the process of injection molding stainless-steel mesh screen 34 (as shown in FIGS. 1-12) or stainless-steel wire screen 38 (as shown in FIGS. 13-24) can be embedded into rubber/silicone coupling device 16. As a result, a user can install screen filter 10 on their turbocharger/supercharger 14 by sliding it over intake 12. Then, the user can secure it to intake 12 of the turbocharger/supercharger 14 with stainless-steel t-bolt clamp 60 or worm gear clamp 62.

The resulting screen filter 10 can be made in several different sizes ranging between 2.5″-6″ inside diameter to cover known turbochargers/superchargers 14. As a result, the instant screen filter 10 may add protection to intake 12 of various size and shape turbocharger/superchargers 14 where other filters are too big to fit.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A screen filter for an intake of a turbocharger/supercharger comprising:
a coupling device having:
a hollow interior;
an open end configured to fit around the intake of the turbocharger/supercharger;
a filter end including a screen; and
a width defined by a distance from the open end to the filter end;
a securing means configured to secure the coupling device around the intake of the turbocharger/supercharger;
wherein, when the coupling device is positioned around the intake of the turbocharger/supercharger, the screen at the filter end is positioned over an end of the intake of the turbocharger/supercharger.

2. The screen filter of claim 1, wherein the screen is positioned adjacent the end of the intake of the turbocharger/supercharger, where the screen is configured to filter debris from entering the intake of the turbocharger/supercharger and to allow substantially unrestricted air flow into the intake of the turbocharger/supercharger.

3. The screen filter of claim 1, wherein the screen is a mesh screen.

4. The screen filter of claim 3, wherein the mesh screen is a stainless-steel mesh screen configured for approximately or equal to 223 pounds per square inch bursting test.

5. The screen filter of claim 1, wherein the screen is a wire screen.

6. The screen filter of claim 5, wherein the wire screen is a stainless-steel honeycomb shaped wire screen with an open area of approximately or equal to 81%.

7. The screen filter of claim 1, wherein the coupling device including a round cross-section with a constant radius, where the hollow interior of the coupling device extending from the open end to the filter end, where the hollow interior having an inner diameter configured to fit around the intake of the turbocharger/supercharger.

8. The screen filter of claim 7, wherein the inner diameter of the hollow interior is between 2.5 inches and 6.00 inches.

9. The screen filter of claim 1, wherein the coupling device having a hollow puck shape, where the width is smaller than an outer diameter.

10. The screen filter of claim 1, wherein the width of the coupling device is sized to allow the securing means to secure the coupling device around the intake of the turbocharger/supercharger.

11. The screen filter of claim 1, wherein the coupling device is made from a flexible material.

12. The screen filter of claim 11, wherein the flexible material of the coupling device is rubber or silicone.

13. The screen filter of claim 1, wherein the coupling device is injection molded with the screen embedded in the filter end, thereby creating a one-piece filter for the intake of the turbocharger/supercharger.

14. The screen filter of claim 1, wherein the securing means is a clamp configured to wrap around the outside of the coupling device over the width of the coupling device, whereby, when the coupling device is inserted over the intake of the turbocharger/supercharger, the clamp is configured to secure the coupling device on the intake by squeezing the coupling device on the intake.

15. The screen filter of claim 14, wherein the coupling device including a channel around the outside of the coupling device between the open end and the filter end configured for maintaining a position of the clamp around the coupling device.

16. The screen filter of claim 14, wherein the clamp is a stainless-steel t-bolt clamp or a stainless-steel worm gear clamp.

17. The screen filter of claim 1, wherein the screen filter is configured to:
allow an engine to gain approximately or equal to 51.4 HP over a standard cone style filter;
allow the engine to gain approximately or equal to 23.2 ft/lbs of torque over the standard cone style filter; or
combinations thereof.

18. A screen filter for an intake of a turbocharger/supercharger comprising:
a coupling device having:
a hollow interior;
an open end configured to fit around the intake of the turbocharger/supercharger;
a filter end including:
a mesh screen configured for approximately or equal to 223 pounds per square inch bursting test; or
a wire screen configured with an open area of approximately or equal to 81%;
a width defined by a distance from the open end to the filter end, where the width is sized to allow a securing means to secure the coupling device around the intake of the turbocharger/supercharger;
a round cross-section with a constant radius, where the hollow interior of the coupling device extending from the open end to the filter end, where the hollow interior having an inner diameter configured to fit around the intake of the turbocharger/supercharger, where the inner diameter of the hollow interior is between 2.5 inches and 6.00 inches;
the coupling device having a hollow puck shape, where the width is smaller than an outer diameter;
the coupling device is made from a flexible material being rubber or silicone;
the securing means is configured to secure the coupling device around the intake of the turbocharger/supercharger, the securing means is a clamp configured to wrap around the outside of the coupling device over the width of the coupling device, whereby, when the coupling device is inserted over the intake of the turbocharger/supercharger, the clamp is configured to secure the coupling device on the intake by squeezing the coupling device on the intake;
wherein, the coupling device including a channel around the outside of the coupling device between the open end and the filter end configured for maintaining a position of the clamp around the coupling device;
wherein, when the coupling device is positioned around the intake of the turbocharger/supercharger, the screen at the filter end is positioned adjacent an end of the intake of the turbocharger/supercharger; and
wherein the screen positioned adjacent the end of the intake of the turbocharger/supercharger is configured to filter debris from entering the intake of the turbocharger/supercharger and to allow substantially unrestricted air flow into the intake of the turbocharger/supercharger;
wherein the coupling device is injection molded with the screen embedded in the filter end thereby creating a one-piece filter for the intake of the turbocharger/supercharger; and
wherein the screen filter is configured to:
allow an engine to gain approximately or equal to 51.4 HP over a standard cone style filter;
allow the engine to gain approximately or equal to 23.2 ft/lbs of torque over the standard cone style filter; or
combinations thereof.

19. An intake of a turbocharger/supercharger comprising:
a screen filter comprising:
a coupling device having:
a hollow interior;
an open end configured to fit around the intake of the turbocharger/supercharger;
a filter end including a screen; and
a width defined by a distance from the open end to the filter end; and
a securing means configured to secure the coupling device around the intake of the turbocharger/supercharger;
wherein, when the coupling device is positioned around the intake of the turbocharger/supercharger, the screen at the filter end is positioned adjacent an end of the intake of the turbocharger/supercharger.

20. The intake of the turbocharger/supercharger of claim 19, wherein the screen positioned adjacent the end of the intake of the turbocharger/supercharger is configured to filter debris from entering the intake of the turbocharger/supercharger and to allow substantially unrestricted air flow into the intake of the turbocharger/supercharger.
